(19) United States
(12) Patent Application Publication
(10) Pub. No.: US 2004/0255007 A1
(43) Pub. Date: Dec. 16, 2004

(54) Method, system and terminal for data networks with distributed caches

(76) Inventors: Juha Salo, Littoinen (FI); Janne Aaltonen, Turku (FI)

Correspondence Address: MORGAN & FINNEGAN, L.L.P., 3 WORLD FINANCIAL CENTER, NEW YORK, NY, 10281-2101, US

(21) Appl. No.: 10/485,800

(22) PCT Filed: Aug. 3, 2001
(86) PCT No.: PCT/EP01/09640

(51) Int. Cl. G06F 15/16

(52) U.S. Cl. 709/219

(57) ABSTRACT

The present invention provides a method of accessing data on a network from a user terminal having a local store and wherein the network is accessed via a service provider, comprising: requesting data; determining whether the requested data is available from the local store and if the data is not available from the local store requesting the requested data from the service provider; and receiving, at the local store, a selection of data from the service provider.

The present invention relates to improvements in network configuration and, more particularly, to improving the system performance, especially in remote network access.

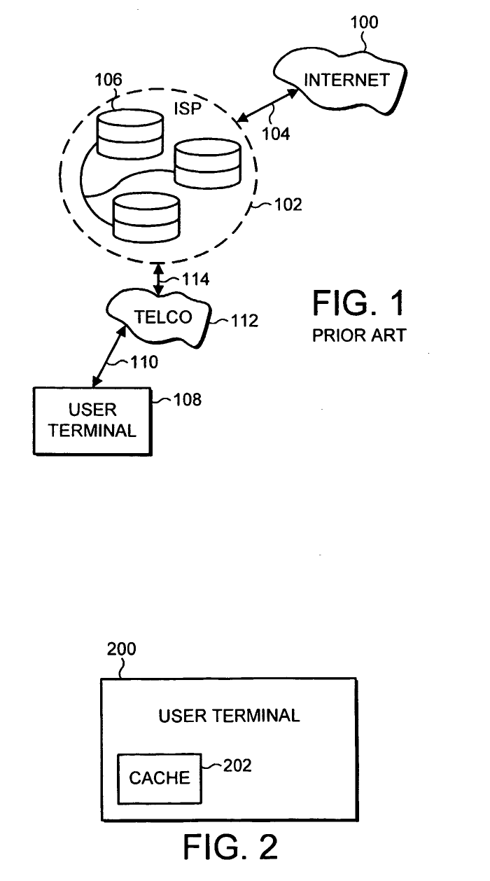

Use of the Internet is expanding rapidly, however the speed of access can still be frustratingly slow. One of the reasons for this is the way in which information is accessed from the Internet, as outlined in FIG. 1. A home user with a user terminal 108 typically connects to the Internet 100 using a dial-up connection 110 to an Internet service provider (ISP) 102, via a telecommunications network 112. When the user terminal 108 requests data from the Internet 100, the ISP 102 will first try to supply that information from large caches 106 which are maintained by the ISP. The caches are huge storage devices, which can typically store many terabytes of data. If the required data is not available in the cache, the ISP requests the data from the Internet and supplies the data to the user terminal 108. The connection 104 between the ISP and the Internet is costly, and is one of the reasons why ISPs maintain such caches. The requested data may be stored in the cache so that if the same data is requested by another user at a later date, the ISP can source the data directly, without having connect to the Internet directly. One of the downsides with such a system is that all data is sourced from the ISP, and data which is not in the ISP cache must be sourced from the Internet. Consequently, retrieving data can be slow.

Currently, a number of Internet browsers, such as Microsoft Internet Explorer and Netscape Navigator, which run on user terminals, keep a local copy of data requested from the ISP. In this way, data which is requested frequently by a user should be available locally, without having to access the ISP. Whilst such a solution can increase the amount of data which is sourced locally, no improvement in performance is achieved when requesting data which has not previously been requested by a user, as such data must still be sourced from the ISP in the manner described above. Similarly, when such data as, for example, the pages of an electronic newspaper which are updated daily or hourly are requested, the local copy is likely to be out-of-date. The present solution is not satisfactory for frequently changing data, as such data must still be sourced from the ISP to ensure that it is up-to-date.

Accordingly, one aim of the present invention is to overcome the above mentioned problems.

According to a first aspect of the present invention, there is provided a method of accessing data on a network from a user terminal having a local store, wherein the network is accessed via a service provider, and wherein the service provider maintains a cache of data available on the network, comprising: requesting data; determining whether the requested data is available from the local store and if the data is not available from the local store requesting the requested data from the service provider; and receiving, at the local store, a selection of data from the service provider.

According to a second aspect of the present invention, there is provided a user terminal for accessing data on a network, the user terminal having a local store, and wherein the network is accessed via a service provider and wherein the service provider maintains a cache of data available on the network, comprising: means for requesting data; a processor for determining whether the requested data is available from the local store; a transceiver for requesting the requested data from the service provider when the requested data is not available from the local store; means for receiving a selection of data from the service provider and storing the received data in the local store.

Advantageously, the present invention speeds up user access of the most frequently accessed or most popular information. By keeping a local copy at the user terminal of selected information from the ISP cache increases the probability that requested data is available locally, without having to access the ISP. Additionally, information may be accessed free of charge without having to connect to an ISP. Further benefits include reducing the demand on existing dial-up servers, since much of the requested information will be sourced locally. For the ISP, the present invention may be used as a further revenue source by charging users for receiving local cache data.

The invention will now be described, by way of example only, with reference to the accompanying diagrams, in which:

FIG. 1 is a block diagram showing an overview of a system according to the prior art;

FIG. 2 is a block diagram showing an embodiment of a user terminal according to the present invention;

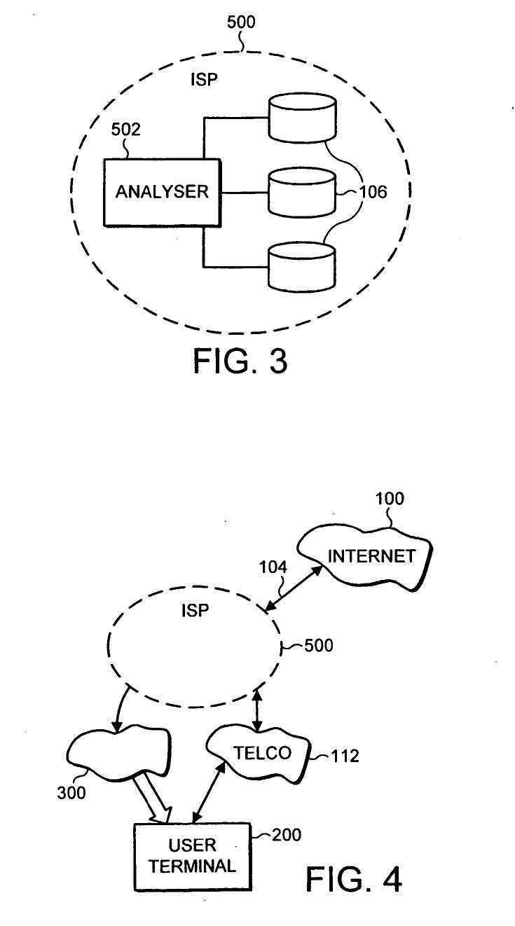

FIG. 3 is a block diagram showing an embodiment of a service provider according to the present invention;

FIG. 4 is a block diagram showing an overview of a system according to an embodiment of the present invention; and

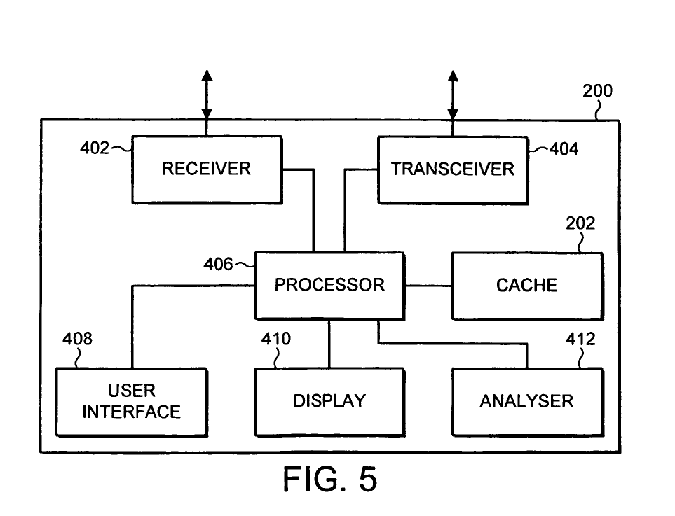

FIG. 5 is a block diagram showing one embodiment of the user terminal 200 in greater detail.

FIG. 1 is a block diagram showing an overview of a system according to the prior art, as described above.

FIG. 2 is a block diagram showing a first embodiment of a user terminal according to the present invention. The user terminal 108 of FIG. 1 is replaced by a user terminal 200 comprising a local cache 202. The local cache 202 can be any storage device with a high capacity, and preferably allows rapid access to the data stored thereon. In a preferred embodiment of the present invention the cache is a high capacity hard disk drive.

The present invention is based on the concept that a selection of the data stored on the ISP cache 106 is downloaded onto the local cache 202. When a user terminal requests data from the Internet, the local cache is checked first of all to see if the requested data is present. If it is present, the data is sourced from the local cache. If the data is not in the local cache, a connection is made with the ISP in the normal manner and the data is sourced by the ISP. By storing a selection of data locally at the user terminal speeds up access times for data which is present in the cache. Requested data which was sourced from the ISP may optionally be stored in the local cache 202.

The way in which data is selected for use in the local cache is described below.

FIG. 3 is a block diagram showing an embodiment of a service provider according to the present invention. The ISP 500 is similar to the ISP 102 of FIG. 1 but additionally comprises an analyser module 502 for keeping and analysing statistics of the usage of the data stored in the caches 106. For example, each time data is requested, by any user, from one of the caches 106, the analyser keeps track of the number of times that data has been requested (this is commonly referred to as the number of hits).

The analyser 502 effectively classifies the cached data according to popularity, and enables all requested data to be ranked according to the number of hits. The analyser can logically reorganise the data on the caches 106 according to the rank, or alternatively may keep a separate listing of ranked data and a link to the actual location of that data on the cache.

The data stored in the ISP cache is based on the requested data from all the user terminals which connect to the ISP. In this way, given the large numbers of users who use an ISP, there is a high probability that the data requested by any individual user will be present in the ISP cache. Caches typically use a renewal algorithm to regularly remove data which has not been accessed recently, thereby ensuring that predominantly only popular information is stored in the cache.

According to one embodiment of the present invention the ISP 500 can arrange for a selection of the ISP cache to be transmitted to the local cache. The part of the ISP cache transmitted could be, for example, 10 Gb of the data with the most hits. If the user terminal receiving this data has a cache smaller than the amount of data being transmitted, it is preferred that the local cache is filled with the most popular data first.

In an alternative embodiment, the ISP cache can be classified into data of different subject areas, and the data in each subject area can be further ranked according to the number of hits. In this embodiment, all of the data is transmitted to the local cache, and the processor 406 of the user terminal decides whether to accept data from each category depending on predefined user preferences. In yet a further alternative embodiment, the ISP can store user preferences for each user terminal, and download the selection of cache data only to those user terminals with matching preferences, using for example a multicast protocol.

By storing the most popular data of the ISP cache in the local cache increases the likelihood that the data required by the user will be found in the local cache.

The present invention provides a number of embodiments offering different ways in which the selected data may be downloaded from the ISP to the local cache.

In one embodiment, the selected data is downloaded over the normal dial-up connection 110. In a further, preferred, embodiment, the user terminal is adapted to receive data from a broadcast or broadband network, as exemplified in FIG. 4. Any suitable point-to-point network could also be used. In this embodiment, the ISP 500 transmits the selection of data for downloading to the local cache to the network 300 from where the data is transmitted to one or more user terminals. Examples of suitable networks include digital video broadcast (DVB) and synchronous digital subscriber line (ADSL). In the case of a broadcast network, such as a DVB network, the very high bandwidths and large coverage makes this an ideal medium for transmitting the selection of data to a large number of user terminals.

The user terminal is preferably arranged to receive the selection of data based on a predetermined schedule, for example, to allow the data to be downloaded overnight or at another time when the user terminal is not is use. Obviously, the user terminal would have to be powered-up in order to receive such a transmission.

FIG. 5 is a block diagram showing one embodiment of the user terminal 200 in greater detail. The user terminal 200 comprises a transceiver 404 for connecting with an ISP via a telecommunications network, as shown in FIG. 3. A receiver 402 is also provided for receiving data from a second network, such as a broadband or broadcast network, as described above. A processor 406 controls the receiver 402, the transceiver 404, a user interface 408, a display 410 and a local cache 202. The user interface 408 and the display 410 enable the user to operate the user terminal as will be appreciated by those skilled in the art. The receiver 402 can be any suitable receiver for receiving data from the network 300. For example, if the network 300 is a DVB network, the receiver 402 is a DVB receiver. The receiver 402 receives a selection of data from the ISP cache and stores the received data, or part of the received data, in the cache 202. Subsequently, when a user requests data from the Internet, the processor first of all checks to see whether the data is available in the cache 202. If the data is available, it is sourced from the cache, otherwise a connection with the ISP is made via the transceiver 404 and the data is sourced from the ISP. The processor 406 also includes a scheduler to enable the selection of data to be received by the receiver 402 and stored in the cache 202 as appropriate. The scheduler may also include timers which can be arranged to power-on the user terminal at a predetermined time in order to receive a scheduled transmission of data. The user terminal 400 also includes an analyser 412, the function of which is described below.

The selection of data from the ISP cache to be downloaded to the local user terminal cache is of prime importance. If the data on the local cache is not representative of the type of the data the user is likely to try and access, then browsing times may well be reduced, due to the additional step of determining whether requested data is present on the local cache, prior to connection to the ISP.

As previously mentioned, the cache of an ISP may typically have a capacity of many terabytes, whereas the local cache is likely to be in the order of tens of gigabytes. Additionally, different user terminals are likely to have caches of differing sizes.

As a result of present invention, much of the data requested by the user will be sourced from the local cache, not from the ISP, eliminating the need to connect to the ISP and greatly increasing performance. In order to maintain accurate usage statistics on the ISP cache, for example for classifying the data according to the number of hits, the user terminal preferably needs to collect the usage data and to provide the ISP with the statistics. Additionally, many Internet pages contain adverts, hits counters and the like, for which the usage statistics also need to be accurately reported back to the advertisers. The analyser 412 shown in FIG. 5 performs just such tasks. The statistical information from the analyser 412 can be fed back to the ISP via the transceiver 404, either on an ad-hoc basis whilst connected to the ISP or, alternatively, this task could be scheduled to take place overnight or when the user terminal is not in use.

The user terminal 200 of FIG. 5 may additionally comprise a security module (not shown) under control the processor 406 which is used to scramble the contents of the local cache. Since the local cache represents the most frequently requested data from a number of different users, it could be possible to analyse the cache data to discover the kind of data other users are requesting. If the majority of users of an ISP work, for example, for one company, other users of the ISP could possibly determine, from the local

1. A method of accessing data on a network from a user terminal having a local store and wherein the network is accessed via a service provider, comprising: requesting data; determining whether the requested data is available from the local store and if the data is not available from the local store requesting the requested data from the service provider; and receiving, at the local store, a collection of data from the service provider, the collection of data being as determined by the service provider and containing data based not exclusively on the data requested by the user terminal.

2. The method of claim 1, wherein the service provider maintains a cache of data available on the network and further wherein the selection of data from the service provider is a selection of data from the cache of data.

3. The method of claim 2, further comprising, selecting a portion of the cache for transmission to the user terminal.

4. The method of claim 2, wherein in the step of selecting further comprises classifying data in the cache according to popularity and selecting a selection of classified data.

5. The method of claim 4, further comprising storing, at the user terminal, a number of predefined user preferences and further wherein the step of receiving is adapted to only receiving data having a classification which matches the defined user preferences.

6. The method of claim 3, further comprising storing, at the service provider, a number of predefined user preferences and transmitting the selection of data to a user terminal based upon the stored user preferences.

7. The method of claim 1, wherein the step of receiving is adapted to receive the selection of data according to a predetermined schedule.

8. The method of claim 7 including receiving the selection of data according to one of a plurality of user selectable subscription preferences.

9. The method of claim 1, further comprising encrypting the contents of the local store.

10. The method of claim 1, wherein the steps of requesting data and supplying the requested data are adapted for requesting data via a first, telecommunications network.

11. The method of claim 1, wherein the step of receiving the selection of data is adapted for receiving the data via a second network.

12. The method of claim 10, wherein the first network is a point-to-point network.

13. The method of claim 11, wherein the second network is a broadcast network.

14. The method of claim 11 wherein the second network is a DVB network.

15. The method of claim 1 including statistically analysing the usage of data from the local store to produce statistical usage data and reporting the statistical usage data to the service provider.

16. The method of claim 15 including carrying out the reporting of the statistical usage data when the user terminal is otherwise inoperative.

17. A user terminal for accessing data on a network from a user terminal having a local store, and wherein the network is accessed via a service provider, comprising: means for requesting data from the network; a processor for determining whether the requested data is available from the local store and if the data is not available from the local store requesting the requested data from the service provider; a receiver for receiving a selection of data from the service provider, the selection of data being as determined by the service provider and containing data not exclusively based on the data requested by the user terminal.

18. The user terminal of claim 17, further comprising means for storing user preferences and wherein the means for receiving the selection of data is adapted to receive data corresponding to the stored user preferences.

19. The user terminal of claim 17, further comprising a scheduler to control the receiver means to receive the selection of data according to a predetermined schedule.

20. The user terminal of claim 17, further comprising encryption means for encrypting and decrypting the contents of the local store.

21. The user terminal of claim 17, including a transceiver adapted for use with a first, telecommunications network.

22. The user terminal of claim 21, wherein the receiver means is operable with a second, wireless network.

23. The user terminal of claim 21, wherein the first telecommunications network is a point-to-point network.

24. The user terminal of claim 22, wherein the second wireless network is a broadcast network.

25. The user terminal of claim 24 wherein the second network is a DVB network.

26. The user terminal of claim 17 including an analyser operable to analyse statistically the usage of data from the local store to produce statistical usage data to be reported to the service provider.

27. The user terminal of claim 26 operable to report the statistical usage data to the service provider when otherwise inoperative.

28. The user terminal of claim 17 coupled to a network including a service provider.
